(19) United States
(12) Patent Application Publication
(10) Pub. No.: US 2016/0158958 A1
(43) Pub. Date: Jun. 9, 2016

(54) DEVICE FOR CUTTING UP TIMBER PARTS

(71) Applicant: Gebrueder Linck Maschinenfabrik "Gatterlinck" GmbH & Co. KG, OBERKIRCH (DE)

(72) Inventor: Werner HINKEL, NEUOETTING (DE)

(21) Appl. No.: 15/045,536

(22) Filed: Feb. 17, 2016

Related U.S. Application Data
(63) Continuation of application No. PCT/EP2014/067386, filed on Aug. 14, 2014.

(30) Foreign Application Priority Data
Aug. 19, 2013 (DE) 10 2013 108 909.7

(51) Int. Cl. B27B 5/22; B27B 31/06; B27B 25/04

(52) U.S. Cl. CPC B27B 5/228; B27B 25/04; B27B 31/06

(57) ABSTRACT

A device for cutting up timber parts. The device comprises a cross conveyor and a longitudinal conveyor which are arranged one behind the other in a direction of conveyance of the timber parts. The device further comprises at least one cross-cut sawing station which is provided upstream of the longitudinal conveyor and comprises a plurality of cross-cut saws. The cross conveyor is provided with conveyor elements upstream of the cross-cut sawing station, the conveyor elements being movable in a first direction. Each of the conveyor elements forms together with a respective one of the plurality of cross-cut saws a common structural unit. The common structural units are individually movable in a second direction transversely to the first direction. The conveyor elements are provided with fixing elements for securing the timber parts on the conveyor elements, and are movable forwards in the first direction and backwards opposite the first direction.

### CROSS REFERENCES TO RELATED APPLICATIONS

This application is a continuation of international patent application PCT/EP2014/067386, filed on Aug. 14, 2014 designating the U.S., which international patent application has been published in German language and claims priority from German patent application DE 10 2013 108 909.7, filed on Aug. 19, 2013. The entire contents of these priority applications are incorporated herein by reference.

### BACKGROUND OF THE INVENTION

This disclosure relates to a device for cutting up timber parts, in particular boards or beams, in which a cross conveyor and a longitudinal conveyor are arranged one behind the other in a direction of conveyance of the boards, wherein at least one cross-cut sawing station is provided upstream of the longitudinal conveyor, and wherein the cross conveyor is provided with conveyor elements upstream of the cross-cut sawing station, the conveyor elements being movable in a cross-conveying direction.

A device of the above-stated type is known from DE 37 07 194 C2.

In sawmills, tree trunks are cut up into timber products which have been worked on all sides. For this purpose, the raw tree trunk is usually firstly freed from its thickened earth end, then measured and, according to the measurement result, cut up into boards, beams, planks, blocks and the like. Below, for the sake of simplicity, only the most frequent case, namely boards, shall be mentioned, while the further comments obviously also relate to planks, beams and the like.

After the tree trunk has been cut up, the raw boards are provided at their margins still with the so-called wane or slab. At their ends too, they are first roughly sawn. The raw boards are therefore measured once again in a further station, in order then, with optimal lumber yield, to obtain cuboid boards which have been worked on all sides. To this end, at predetermined positions, marginal longitudinal cuts (edging cuts) or end-side cross-cuts (cross-cuts). In this way, the regions with slab are cut off, the board is cross-cut to a predetermined length, and the roughly sawn surfaces which may still be present at the end are smoothed.

From document DE 37 07 194 C2 which has already been cited above, a device for positioning and aligning sawn timber during transfer by means of conveyors is known. In this known device, the raw boards are delivered in the transverse direction to a cross conveyor, which forwards the boards in the transverse direction. The cross conveyor has a plurality of parallel conveyor chains. The conveyor chains are provided with upwardly protruding dogs, which come to bear against the rear longitudinal side, thus the rear edge of the boards, and push these before it in the cross-conveying direction. The dogs here bear only loosely against the boards. At the outlet of the cross conveyor, the boards are delivered one after another to a longitudinal conveyor, on which they consequently rest one behind another and are successively further worked or further cut up in a sawing unit, for instance an edging saw, a frame saw of a multiple band saw, or a double-shaft circular sawing unit.

Since the boards, when delivered onto the cross conveyor, assume no defined position, but rest with their longitudinal axis in an uncontrolled manner obliquely to the perpendicular to the cross-conveying direction, it is necessary to align them at a defined angle transversely to the conveying direction. This defined angle depends on the individual form of the board and takes account of the fact, for example, that the board is wider at one end than at the other end. For this purpose, the cross conveyor in the known device is configured as a so-called straightening bench. In the region of the straightening bench, the boards are firstly measured by means of a measuring device, so that their individual position and shape are known. In the region of the straightening bench, the individual conveyor chains are also individually movable. As a result, the dogs can acquire a specific phase shift of the movement and can exactly align the board pushed by them such that the board eventually in a desired alignment makes its way onto the longitudinal conveyor and then into the sawing unit.

In an illustrative embodiment of the known device (pos. 23 in FIG. 13), in the region of the straightening bench is further provided a cross-cut saw. This is arranged in a spatially fixed manner next to one of the two outermost conveyor chains and is therefore only suitable for sawing off as waste pieces possible projections of the boards which have been pushed past it.

The known device therefore has the drawback that, following the alignment of the raw boards, only an end-side cropping of the length of excessively long boards which have a so-called end slab, that is to say a slab region which runs around one end of the raw board, is possible. The known device enables no individual cutting to length of the boards prior to delivery to the longitudinal conveyor, and no processing of boards with so-called saddle slab. By this it is understood boards which, though they are sawn off at both ends and also have sawn surface regions there, are provided in the central region, over their entire width, with slab.

From document US 2004/0163525 A1 is known a sawing device in which boards which have already been worked on all sides and are of slightly different lengths are cut to length to a predefined measurement. The boards are fed to a cross-cut sawing unit by means of a cross conveyor. They here lie on the cross conveyor in an alignment exactly transversely to the conveying direction and such that they are mutually offset alternately to the left and right in the conveying direction. As soon as, for example, the board which has been offset to the left enters into the cross-cut sawing unit, it is sawn off at its right end by a first, fixedly installed “drop saw” and at its left end by a “trimmer” which is maneuverable in the transverse direction. The following board, which is offset to the left, is then cross-cut by a second, likewise fixedly installed drop saw, and by a trimmer, which is arranged to the far right in the conveying direction and is likewise maneuverable in the transverse direction. The sawing device therefore serves for the mass production of boards of identical dimensions for so-called box stacks. In one illustrative embodiment of the known device, it is further provided to fix the boards on the conveyor chains of the cross conveyor. For this purpose, the conveyor chains are provided with pivotable hooks, which hang loosely downward in the lower strand of the conveyor chain and, as they pass into the upper strand, are pivoted upward by means of a guide rail in order to press the board, in the region of its rear longitudinal edge, onto the conveyor chain.

This known sawing device has the drawback that an individual working of boards, in particular of boards which are still waney, is not possible. In addition, the known sawing device requires that the boards are fed to it in an exactly predefined position and alignment. The fixing of the boards by means of pivotable hooks fastened to the conveyor chains has the drawback that the hooks are movable with the conveyor chains only in one direction, so that only the function of a hold-down device is achieved.

From document DE 69 16 326 U is known a cross-cut saw for edged boards. In this saw, a plurality of, for instance three circular saw blades are arranged at a predefined distance apart. Next to the inner side of the two outer circular saw blades and on both sides of the inner circular saw blade is found a conveyor chain with dogs or gripping members for the boards which are to be sawn. In one illustrative embodiment, the gripping members can hold the boards by means of frictional engagement.

In this known saw too, individual working is not possible. The saw likewise also requires a prior alignment of the boards which are to be sawn.

### SUMMARY OF THE INVENTION

It is an object to refine a device of the type stated in the introduction such that the aforementioned drawbacks are avoided. In particular, a device in which the raw boards can be aligned and cut to length individually and with high precision already in the region of the cross conveyor, thereby enabling the processing of boards with saddle slab, are intended to be provided.

In view of this object, a device is provided for cutting up timber parts comprising:
a cross conveyor and a longitudinal conveyor which are arranged one behind the other in a direction of conveyance of the timber parts, and
at least one cross-cut sawing station which is provided upstream of the longitudinal conveyor and comprises a plurality of cross-cut saws,
wherein the cross conveyor is provided with conveyor elements upstream of the cross-cut sawing station, the conveyor elements being movable in a first direction,
wherein each of the conveyor elements forms together with a respective one of the plurality of cross-cut saws a common structural unit,
wherein said common structural units are individually movable in a second direction transversely to the first direction, and
wherein the conveyor elements are provided with fixing elements for securing the timber parts on the conveyor elements, and wherein the conveyor elements are movable forwards in the first direction as well as backwards opposite the first direction.

Thus, the boards are held fixed in the region of the cross conveyor by means of individually maneuverable structural units of cross-cut saw and cross conveyor elements. The fixing of the boards, in conjunction with the reversibility of the conveying direction, here allows the boards to be aligned in terms of their orientation in relation to a perpendicular to the conveying direction. This makes it possible to perform a substantially more individual working of the raw board prior to delivery to the longitudinal conveyor. In contrast to the prior art which has been discussed above, thus not only is a mass production possible, but waney boards can also be delivered to the cross conveyor in almost any chosen alignment. As a result, further working stations are spared and boards whose processing is not possible with the traditional device are also able to be processed.

In a refinement, the fixing elements secure the boards by non-positive engagement.

This measure has the advantage that the fixing can be effected with technically relatively simple means.

Alternatively, it is also possible for the fixing elements to secure the boards by positive engagement.

This measure is technically somewhat more complex, but has the advantage that thicker, i.e. heavier boards can also be fixed.

Further advantages emerge from the description and the appended drawing.

Obviously, the aforementioned advantages are usable not only in the respectively stated combination, but also in other combinations or in isolation without departing from the spirit and scope of the present invention.

### BRIEF DESCRIPTION OF THE DRAWINGS

FIG. 1 shows an extremely schematized top view of an illustrative embodiment of a device according to this disclosure,

FIG. 2 shows a schematic representation for illustrating an illustrative embodiment of a corresponding method, as can be executed on the device according to FIG. 1 for a raw board with end slab; and

FIG. 3 shows a representation similar to FIG. 2, yet for the case of a raw board with saddle slab.

### DESCRIPTION OF PREFERRED EMBODIMENTS

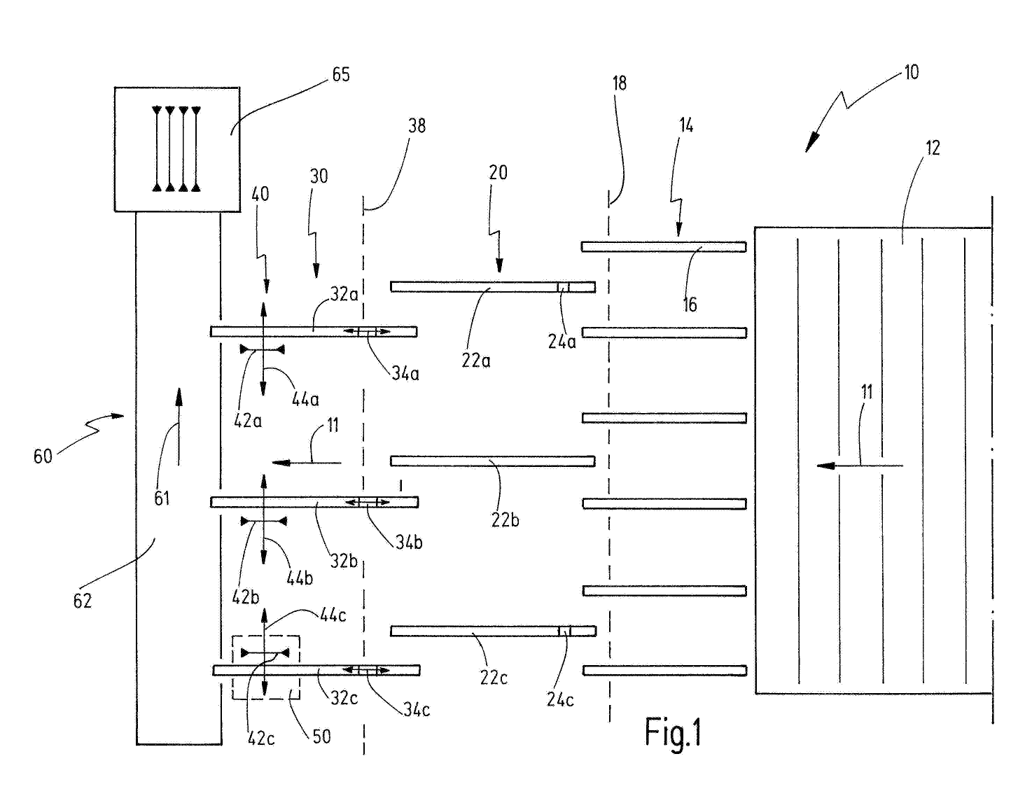

In FIG. 1, 10 denotes an illustrative embodiment of a device according to this disclosure, namely a sawmill plant, in its entirety. In the plant 10, timber parts, for instance raw boards, beams, planks and the like, are firstly conveyed transversely, as indicated with a cross-conveying direction 11. For the following description too, it is the case that, for the sake of simplicity, only boards are mentioned, though other elongate, raw timber parts such as beams, blocks and planks are also obviously jointly meant. It is also obvious that the present disclosure is not limited to sawmill plants. It can be used, for instance, also in timber-finishing businesses such as carpenter's workshops and the like, where boards run via a cross conveyor/longitudinal conveyor arrangement and are cross-cut in the process.

The planks firstly make their way onto a standard board separator 12, which in side view is S-shaped and directed upward. The board separator 12 then delivers the boards in still undefined alignment successively to a first cross conveyor 14, which in traditional construction consists of a plurality of parallel first conveyor elements 16 extending in the cross-conveying direction 11. These conveyor elements 16 can be configured, for example, as toothed conveyor chains or as belt conveyors.

Preferably in the region of the first cross conveyor 14 can be found a first measuring plane 18, indicated with a dashed line in FIG. 1. In this measuring plane 18, the incoming planks are recorded and assessed. This can alternatively be done by an operator or a measuring device. A measuring device can take measurements, for example, by means of a movable laser fan, camera or the like, if need be also in 3D representation. The signals of the first measuring plane 18 can be fed to a computer (not represented), which derives control signals therefrom. This procedure is known to the person skilled in the art. The first measuring plane 18 serves in particular to define the position of the cross-cuts which are later to be carried out and the position of a narrow side of the boards, thus their reference position.

Downstream of the first cross conveyor 14 is arranged a second cross conveyor 20, which can have a plurality of second conveyor elements 22a, 22b, 22c. Of these, at least two, in the represented illustrative embodiment the conveyor elements 22a and 22c, can be equipped with a dog 24a and 24c respectively. These dogs 24a, 24c are individually controllable in terms of their movement in the cross-conveying direction 11, so that a board resting on the second cross conveyor 20 can be adjusted in its alignment transversely to the cross-conveying direction 11. This procedure is likewise known to the person skilled in the art, for instance from document DE 37 07 194 C2 cited in the introduction, or document DE 42 32 530 C2. The second cross conveyor 20 with the alignment function can also be dispensed with if the alignment function is taken over by another part of the plant, as will yet be described.

In the cross-conveying direction 11, a third cross conveyor 30 now follows. This too possesses a plurality of conveyor elements, namely third conveyor elements 32a, 32b and 32c. At this point it should be noted that the number of conveyor elements of the described cross conveyors can obviously vary, depending on the size and complexity of the respective sawmill plant. The represented cross conveyors 14, 20 and 30 can also, where possible and sensible, be structurally combined or further divided without this departing from the spirit and scope of the present invention.

The special feature of the third conveyor elements 32a, 32b, 32c is that they are provided with fixing elements 34a, 34b, 34c. By the term fixing element it should here be understood, in contrast to traditional dogs such as 24a and 24c in the present description, that they do not push a board loosely before them, but grab hold of and secure the board. This can be done in a variety of ways within the scope of the present invention. In a preferred embodiment, the boards are held positively by the fixing elements 34a, 34b, 34c, in that they are grasped on their top and bottom sides by means of, for example, tong-like grippers. Grippers of this type are known to the person skilled in the art. They are offered, for instance, under the designation “Tong Loader” by the company PLC Inc., Senneterre (Ontario), Canada, and are described in documents U.S. Pat. No. 5,752,594 and U.S. Pat. No. 5,931,287. Alternatively, the boards can also be held non-positively by the fixing elements 34a, 34b, 34c, in particular by clamping between a clamping piece and a conveyor belt. In any event, the boards are in this way immovably connected to a conveyor belt or the like, so that the boards can be moved in the cross-conveying direction 11 both forward and backward, thus reversingly. In FIG. 1, this is indicated by double arrows at the fixing elements 34a, 34b, 34c. The fixing of the boards also means that these can also be moved counter to an acting force, thus in particular counter to a rotating circular saw blade or counter to a running band saw blade.

In the transition between the second cross conveyor 20 and the third cross conveyor 30, a second measuring plane 38 is preferably further provided. In this second measuring plane 38, the width and, if need be, also the cross-sectional form of the product to be produced, is preferably defined. In this respect too, it is obvious that the number and positioning of measuring planes is variable within wide ranges within the scope of the present invention.

In the end region of the third cross conveyor 30 is found a cross-cut sawing station 40. This preferably comprises a plurality of cross-cut saws 42a, 42b, 42c, which further preferably corresponds to the number of third conveyor elements 32a, 32b, 32c. As indicated with arrows 44a, 44b, 44c, the cross-cut saws 42a, 42b, 42c are movable by means of a drive (not represented) on a support transversely to the cross-conveying direction 11, namely in particular individually. At 50 is indicated that the cross-cut saws 42a, 42b, 42c, with associated third conveyor elements 32a, 32b, 32c, can be combined into a structural unit. With regard to the desired maneuverability of the cross-cut saws 42a, 42b, 42c, possibly together with associated third conveyor elements 32a, 32b, 32c, it is obvious that design measures have been taken in order to rule out a collision with other elements, in particular the second conveyor elements 22a, 22b, 22c. This can be effected, for instance, by pivoting of these elements, perpendicular to the plane of the drawing, during the process. This too is known to the person skilled in the art and does not need further elucidation here.

The third conveyor elements 32a, 32b, 32c are configured such that they deliver the boards finally onto a longitudinal conveyor 60, which has a fourth conveyor element 62 movable in the longitudinal conveying direction 61. The fourth conveyor element 62 is preferably a conveyor chain having pressure rollers arranged above it. The conveying directions 11 and 61 lie preferably perpendicular to each other.

Downstream of the longitudinal conveyor 60 can be found a sawing station 65, for instance an edging saw, a frame saw, a multiple band saw, or a double-shaft circular saw, or some other finishing station.

The operating method of the sawmill plant 10 shall now be explained on the basis of two examples.

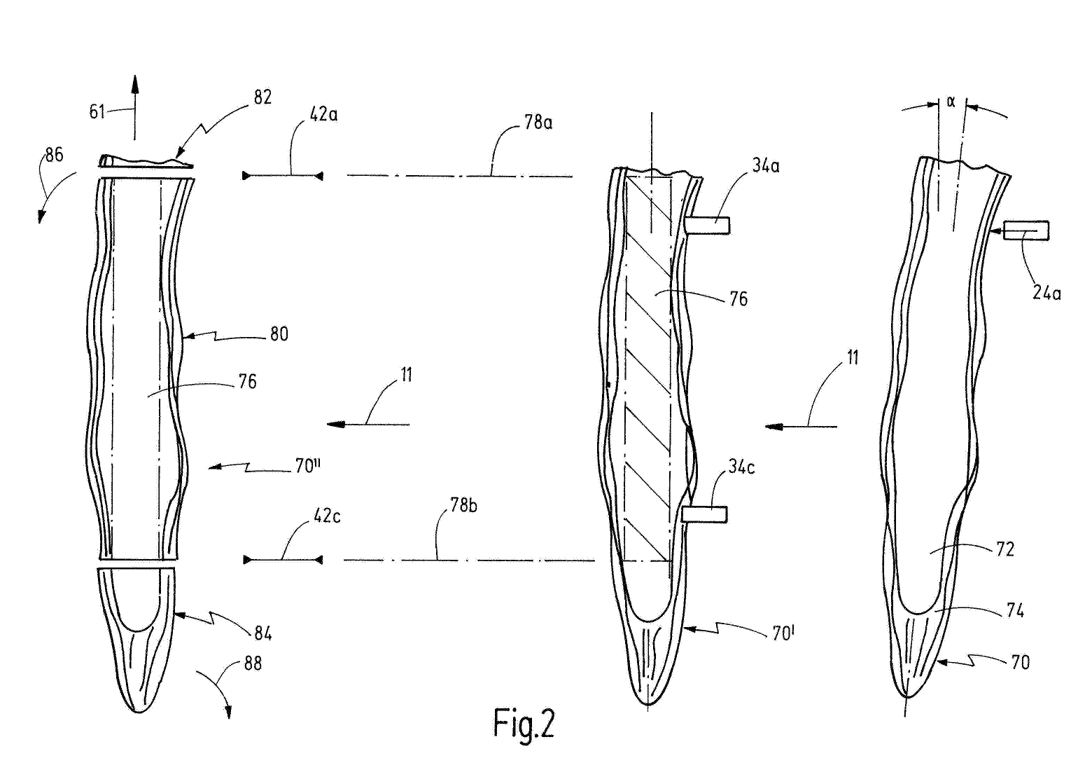

FIG. 2 shows on the right a raw board 70. The board 70 is provided in some regions with a sawn surface 72, for the rest is covered by a so-called end slab 74. The upper end of the board 70 is in general only roughly sawn, in particular if it has been produced upon felling of the tree. The lower end, on the other hand, is unsawn. The board 70 is also still aligned in an undefined manner, as indicated with an angle α.

After the position of the board 70, in particular the longitudinal position of the cross-cuts yet to be performed, has been determined in the first measuring plane 18, the alignment can be corrected by means of the dog 24a, as described above in the introduction. Since the extent of this correction is generally small, it can also be performed after the determination of the position of the cross-cuts. As already mentioned, the second longitudinal conveyor 20 with the dogs 24a, 24b can also be dispensed with. In this case, the alignment function can be partially taken over by fixing elements 34a, 34b and 34c of the third cross conveyor 30. The board 70 is now conveyed with alignment 70′ in the cross-conveying direction 11, as represented in the middle of FIG. 2. From the measurement signals of the first measuring plane 18 or alternatively of the second measuring plane 38, in the computer an optimal timber product 76, which has been worked on all sides, is defined in the board 70′, thus, for instance, a board which is shown in hatched representation in the middle of FIG. 2. Obviously a plurality of boards can be defined in this way.

The end faces of the timber product 76 define positions 78a and 78b for two circular cross-cut saws, for instance 42a and 42c, which are maneuvered into these positions 78a and 78b. At the same time, fixing elements, for instance the elements 34a and 34c, engage on the rear edge of the board 70′ and move this further in the cross-conveying direction 11 to the circular cross-cut saws 42a and 42b. The fixing elements 34a and 34b grab hold of the board 70′, here preferably within the portion defined by the positions 78a and 78b. As soon as the board 70′ is held fixed, the second measuring station 38 performs its measurement and defines the longitudinal cuts to be performed in the following sawing station 65. It is here important that the fixing elements 34a and 34b hold the board 70′ in the defined position until it is deposited on the longitudinal conveyor 60.

Once the fixing elements 34a and 34b have guided the board 70′ through the circular cross-cut saws 42a and 42c (FIG. 2, left), a cut-up board 70″, which in the middle comprises a main product 80 and at the ends waste pieces 82 and 84, is formed. The latter are disposed of laterally, as indicated with arrows 86 and 88. The main product 80, on the other hand, makes its way in defined position onto the longitudinal conveyor 60 and is fed in the longitudinal conveying direction 61 to the sawing unit 65.

As follows from the above, the sequence of the individual steps, in particular the “cross-cutting”, “measuring” and “aligning” steps, can be chosen differently and realized at different positions of the plant. Thus an incoming board can firstly be measured, then aligned, and finally cross-cut. Conversely it is also equally possible, however, to cross-cut the board firstly at predetermined positions, to then measure it, and to align it only directly prior to delivery to the longitudinal conveyor.

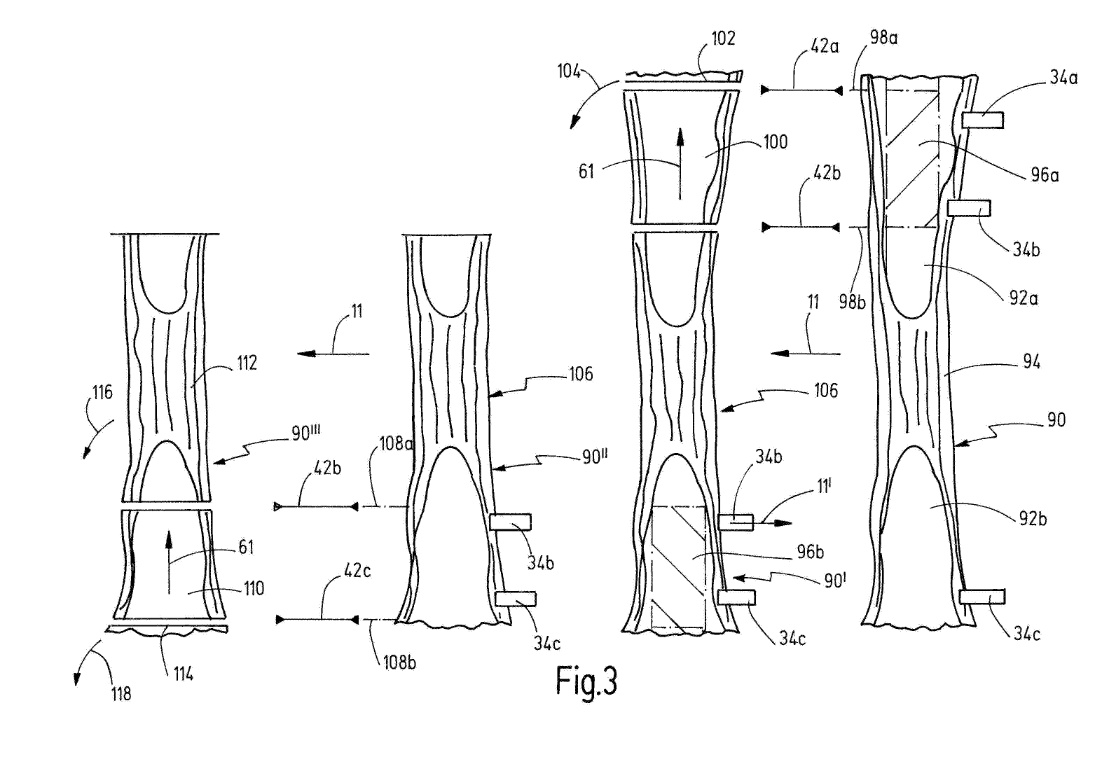

In the illustrative embodiment according to FIG. 3, a raw board 90, which at both ends has sawn surfaces 92a and 92b respectively, yet in the middle is covered by a so-called saddle slab 94, is processed. As is readily apparent, the method according to FIG. 2 cannot be applied in the case of this board 90.

In the representation of FIG. 3, the board 90 is already in the measured and aligned state induced in accordance with the procedure of FIG. 2. The further cut-up operation has likewise been defined by the measurement, here with an upper timber product 96a illustrated in hatched representation in FIG. 3.

The board 90 is now (cf. board 70′ in FIG. 2) grabbed at its rear edge by two fixing elements 34a and 34b. Two circular cross-cut saws, for instance the circular cross-cut saws 42a and 42b, have been maneuvered into positions 98a and 98b respectively, which are defined by the end faces of the upper timber product 96a. By means of the third cross conveyor 30, the board 90 is now guided through the circular cross-cut saws 42a and 42b, so that, as the cut-up board 90′, a first main product 100 and a waste piece 102 are formed, the latter is disposed of at 104. By contrast, the first main product 100 is removed on the longitudinal conveyor 60 in the longitudinal conveying direction 61. In addition, an offcut 106 is formed. This is grabbed on its rear edge by fixing elements, for instance the elements 34b and 34c, which for this purpose have been maneuvered into the positions represented in FIG. 3 and withdrawn counter to the cross-conveying direction 11. As a result, the offcut 106 makes its way back out of the region of the circular cross-cut saws 42a and 42b.

At the same time, the offcut 106 is measured, for instance in the second measuring plane 38, and a lower timber product 96b is defined in the offcut 106.

The circular cross-cut saws, for instance the circular cross-cut saws 42b and 42c, are maneuvered only into positions 108a and 108b respectively, which are defined by the end faces of the lower timber product 96b. As shown at 90″, the motional direction of the third cross conveyor 30 is now reversed again and the fixing elements 34b and 34c convey the offcut 106 in the cross-conveying direction 11 through the circular cross-cut saws 42b and 42c. As a result, a second main product 110, as well as two waste pieces 112 and 114, which are disposed of at 116 and 118 respectively, are formed. By contrast, the main product 110 is fed to the longitudinal conveyor 60 and removed in the longitudinal conveying direction 61.

Here too it is obvious that the specified selection of fixing elements and of circular cross-cut saws, as well as the sequence of steps, should be understood only on an illustrative basis and depends on the circumstances of the individual case.

In this way, it is possible, for instance, to vary the procedure according to FIG. 3 such that, in total, four third conveyor elements 32 and four circular cross-cut saws 42 with fixing elements 34 are employed.

In this case, two fixing elements and two circular cross-cut saws are used to saw out the first main product 100 in the manner already described. At the same time, however, two further fixing elements already engage on the offcut 106. While then the first two fixing elements advance the first main product 100 to the longitudinal conveyor 60, the two further fixing elements withdraw the now sawn-off offcut 106 and advance it straight back through the two further circular cross-cut saws and onward to the longitudinal conveyor 60. As a result, cut-up operations proceed in parallel, which likewise increases the capacity throughout the plant 10.

What is claimed is:

1. A device for cutting up timber parts comprising:
a cross conveyor and a longitudinal conveyor which are arranged one behind the other in a direction of conveyance of the timber parts, and
at least one cross-cut sawing station which is provided upstream of the longitudinal conveyor and comprises a plurality of cross-cut saws,
wherein the cross conveyor is provided with conveyor elements upstream of the cross-cut sawing station, the conveyor elements being movable in a first direction,
wherein each of the conveyor elements forms together with a respective one of the plurality of cross-cut saws a common structural unit,
wherein said common structural units are individually movable in a second direction transversely to the first direction, and
wherein the conveyor elements are provided with fixing elements for securing the timber parts on the conveyor elements, and wherein the conveyor elements are movable forwards in the first direction as well as backwards opposite the first direction.

2. The device as claimed in claim 1, wherein the fixing elements secure the timber parts by non-positive engagement.

3. The device as claimed in claim 1, wherein the fixing elements secure the timber parts by positive engagement.

4. The device as claimed in claim 1, wherein at least one measuring plane is provided for measurement of the timber parts.

5. The device as claimed in claim 1, wherein a sawing station is arranged downstream of the longitudinal conveyor.
